(19) United States
(12) Patent Application Publication
(10) Pub. No.: US 2004/0167802 A1
(43) Pub. Date: Aug. 26, 2004

(54) Information collection and provision system and information collection and provision method

(75) Inventors: Yoichi Takada, Otawara-Shi (JP); Akihiro Miyauchi, Kuroiso-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-Shi (JP)

(21) Appl. No.: 10/784,770

(22) Filed: Feb. 24, 2004

(30) Foreign Application Priority Data
Feb. 26, 2003 (JP) 2003-049744

(51) Int. Cl. G06F 17/60

(52) U.S. Cl. 705/2

(57) ABSTRACT

The present invention is characterized by including: an information collection and provision system which receives use information on a state of use of plural medical apparatuses set in medical facilities and apparatus information on the medical apparatuses themselves, which are acquired by the plural medical apparatuses, via a network and stores the information; and a client terminal which accesses the information collection and provision system, sends a kind and a display format of the use information and the apparatus information to the information collection and provision system as setting information, and receives information obtained on the basis of the setting information from the information collection and provision system and displays the information. According to the constitution, a medical information and collection system with which a user is capable of obtaining desired information in a desired format can be provided.

### BACKGROUND OF THE INVENTION

1. Field of the Invention

The present invention relates to an information collection and provision system for medical apparatuses which can collect and provide information on states of plural medical apparatuses on the basis of a request from a user. In addition, the present invention relates to an information collection and provision method for medical apparatuses.

2. Description of the Related Art

In general, there are a large number of medical apparatuses which are set in hospitals, and these medical apparatuses are required to be used effectively. Therefore, it is necessary for efficiency of use to grasp states of use thereof from various angles. For example, in a radiology department which installs imaging diagnostic apparatuses and provides image information on subjects and information for diagnostic reports, it is an important challenge from the viewpoint of efficiency of businesses to realize effective use of the apparatuses.

There are known systems for analysis and reporting on management of medical facilities in which the medical apparatuses are set. However, these systems do not provide users with information on medical apparatuses, which are set in plural places, in formats desired by the users.

For example, there is a demand that daily reports should be provided in a format which can be directly used in examinations in audit organizations, the government, and the like. On the other hand, as a matter of fact, such a format varies depending upon an organization or a regional community, which performs examination.

### SUMMARY OF THE INVENTION

The present invention has been devised in view of the above-mentioned problems of the conventional information collection system for medical apparatuses, and it is an object of the present invention to provide a medical information collection system and the like which are capable of providing users with information desired by users in formats desired by the users.

In order to solve the above-mentioned problems, according to a first aspect of the present invention, there is provided an information collection and provision system which is characterized by including: a first data table which stores medical apparatus information, which indicates an operation state of a medical apparatus, acquired via a network; user identifying unit which authenticates user identification information (ID) acquired from a remote terminal apparatus; a second data table which stores report delivery condition information, which is acquired from the terminal apparatus, in association with the user identification information (ID); report delivery judging unit which judges whether or not it is a time for delivering a report on the basis of the first data table and the report delivery condition information; report preparing unit which prepares a report on the basis of the result of judgment by the report delivery judging unit; and output unit which outputs a result of preparation of a report by the report preparing unit via a network.

Preferably, the report shows information on at least one of the group consisting of an operation time of the medical apparatus, the number of patients examined by the medical apparatus, the number of examinations, an irradiation time of X-ray, a plan setting time for patients, a processing time after photographing, an idle time of the medical apparatus, an examination time for patients, and the number of slices at which tomograms have been obtained.

In addition, the report preparing unit may include: emergency report delivery judging unit which determines delivery of a report when abnormality of performance is detected on the basis of parameters representing an examination state or information on the apparatus; and periodical report delivery judging unit which decides to distribute a report in every predetermined period.

More preferably, it is also possible to constitute the report preparing unit so as to include: a template selection module which selects a desired template out of plural templates defining contents, an arrangement, and a format of a report stored in the second data table; a template setting module which changes the selected template to a template for desired contents, arrangement, and format and prepares a new template; and a format setting module which changes a font size, a font color, a graph color, and a background color of the template to desired ones.

Next, according to another aspect of the present invention, there is provided an information collection and provision system which is characterized by including: a first data table which stores medical apparatus information which indicates an operation state of a medical apparatus, acquired via a network; user identifying unit which authenticates user identification information (ID) acquired from a remote terminal apparatus; a second data table which stores report output format information which is acquired from the terminal apparatus, in association with the user identification information (ID); report preparing unit which prepares a report for users using the medical apparatus information on the basis of the report output format information; and output unit which outputs a result of preparation of a report by the report preparing unit via a network.

Further, according to another aspect of the present invention, there is provided an information collection and provision system which is characterized by including: a first data table which stores medical apparatus information which indicates an operation state of a medical apparatus acquired via a network; user identifying unit which authenticates user identification information (ID) acquired from a remote terminal apparatus; a second data table which stores report delivery time information which is acquired from the terminal apparatus, in association with the user identification information (ID); report delivery judging unit which judges whether or not it is a time for delivering a report on the basis of the first data table and the medical apparatus information; report preparing unit which prepares a report on the basis of the result of judgment by the report delivery judging unit; and output unit which outputs a result of preparation of a report by the report preparing unit via a network.

On the other hand, according to another aspect of the present invention, there is provided an information collection and provision method which is characterized by including: a first storage step of storing medical apparatus information which indicates an operation state of a medical apparatus acquired via a network in a data table; a user identification step of authenticating user identification information (ID) acquired from a remote terminal apparatus; a second storage step of storing report delivery condition information which is acquired from the terminal apparatus, in association with the user identification information (ID) in a data table; a report delivery judgment step of judging whether or not it is a time for delivering a report on the basis of the data table in which the medical apparatus information is stored in the first storage step, and the report delivery condition information; a report preparation step of preparing a report on the basis of the result of judgment by the report delivery judgment step; and an output step of outputting a result of preparation of a report by the report preparation step via a network.

In addition, according to another aspect of the present invention, there is provided an information collection and provision method which is characterized by including: a first storage step of storing medical apparatus information which indicates an operation state of a medical apparatus acquired via a network in a data table; a user identification step of authenticating user identification information (ID) acquired from a remote terminal apparatus; a second storage step of storing report output format information which is acquired from the terminal apparatus, in association with the user identification information (ID) in a data table; a report preparation step of preparing a report for users using the medical apparatus information on the basis of the report output format information; and an output step of outputting a result of preparation of a report by the report preparation step via a network.

Further, according to another aspect of the present invention, there is provided an information collection and provision method which is characterized by including: a first storage step of storing medical apparatus information which indicates an operation state of a medical apparatus acquired via a network in a data table; a user identification step of authenticating user identification information (ID) acquired from a remote terminal apparatus; a second storage step of storing report delivery time information acquired from the terminal apparatus in association with the user identification information (ID) in a data table; a report delivery judgment step of judging whether or not it is a time for delivering a report on the basis of the data table in which the medical apparatus information is stored in the first storage step, and the medical apparatus information; a report preparation step of preparing a report on the basis of the result of judgment by the report delivery judgment step; and an output step of outputting a result of preparation of a report by the report preparation step via a network.

As described above, according to the present invention, a medical information collection system and the like, which are capable of obtaining information desired by users in formats desired by the users, can be obtained.

Specific constitutions and characteristics of the present invention will be made apparent by embodiments of the invention described below and the accompanying drawings.

### BRIEF DESCRIPTION OF THE DRAWINGS

In the accompanying drawings:

FIG. 1 is a block diagram showing an entire constitution of an embodiment of the present invention;

FIG. 2 is a diagram showing an example of use information in the embodiment of the present invention;

FIG. 3 is a flowchart of report notice processing with an electronic mail which is performed by an information collection and provision system;

FIG. 4 is a flowchart of processing which is performed by an information collection and provision system 13 in response to a request from a web browser of a user;

FIG. 5 is a diagram explaining a transmission setting mode for performing designation of apparatus use information and setting of a display format;

FIG. 6 is a diagram explaining a display mode for obtaining and displaying predetermined information in a client terminal on the basis of setting information;

FIG. 7 is a diagram showing an example of an input screen which is displayed on a web browser first;

FIG. 8 is a diagram showing an example of a screen which displays states of use/environment on the web browser;

FIG. 9 is a diagram showing an example of a screen for setting notice conditions for a report on the web browser;

FIG. 10 is a diagram showing an example of a format setting screen which is displayed on the web browser;

FIG. 11 is a diagram showing an example of a screen for setting notice conditions for a report with an electronic mail;

FIG. 12A is a diagram showing a display example of a screen for displaying a report in the case in which an index item is temperature;

FIG. 12B is a diagram showing a display example of the screen for displaying a report in the case in which the index item is humidity;

FIG. 12C is a diagram showing a display example of the screen for displaying a report in the case in which the index item is an input power level;

FIG. 12D is a diagram showing a display example of the screen for displaying a report in the case in which the index item is the number of slices;

FIG. 13A is a diagram showing a display example in the case in which a value of a period input section is changed and “latest four weeks” is selected;

FIG. 13B is a diagram showing a display example in the case in which a value of the period input section is changed and “latest four quarters” is selected;

FIG. 13C is a diagram showing a display example in the case in which a value of the period input section is changed and “latest twelve months” is selected;

FIG. 14 is a diagram showing an example of a setting state of a report for each user which is stored in a setting information DB;

FIG. 15 is a diagram showing an example of converting primary data collected from a diagnostic apparatus into values (secondary data) of index items for generating a graph, a table, and the like;

FIG. 16A is a diagram showing an example of a template for a report;

FIG. 16B is a diagram showing another example of the template for a report;

FIG. 17 is a conceptual block diagram of a constitution for performing template setting processing for a report;

FIG. 18 is a diagram showing an example of a main screen concerning template setting;

FIG. 19 is a diagram showing an example of an input screen for setting or changing an arrangement in a template; and

FIG. 20 is a diagram showing an example of an input screen for setting or changing a format of a template.

### DESCRIPTION OF THE PREFERRED EMBODIMENTS

An information collection and provision system of the present invention collects operation information of an operator of a medical apparatus (a medical diagnostic apparatus, an information system, etc.), signal detection information of each part of the apparatus, and information on an operation state such as environmental information, analyzes contents of the information, and provides a user with a state of use, an abnormality occurrence state, environmental information, and the like of the apparatus.

Examples of the medical diagnostic apparatus include an X-ray tomography apparatus (CT apparatus), a nuclear magnetic resonance imaging apparatus (MRI apparatus), an X-ray diagnostic apparatus, an ultrasonic wave diagnostic apparatus, and a nuclear medicine diagnostic apparatus (these are generally called“modality”). Examples of the information system include a picture archiving and communication system (PACS) and an information system for radiology department.

First Embodiment

A first embodiment of the present invention will be hereinafter described with reference to the accompanying drawings.

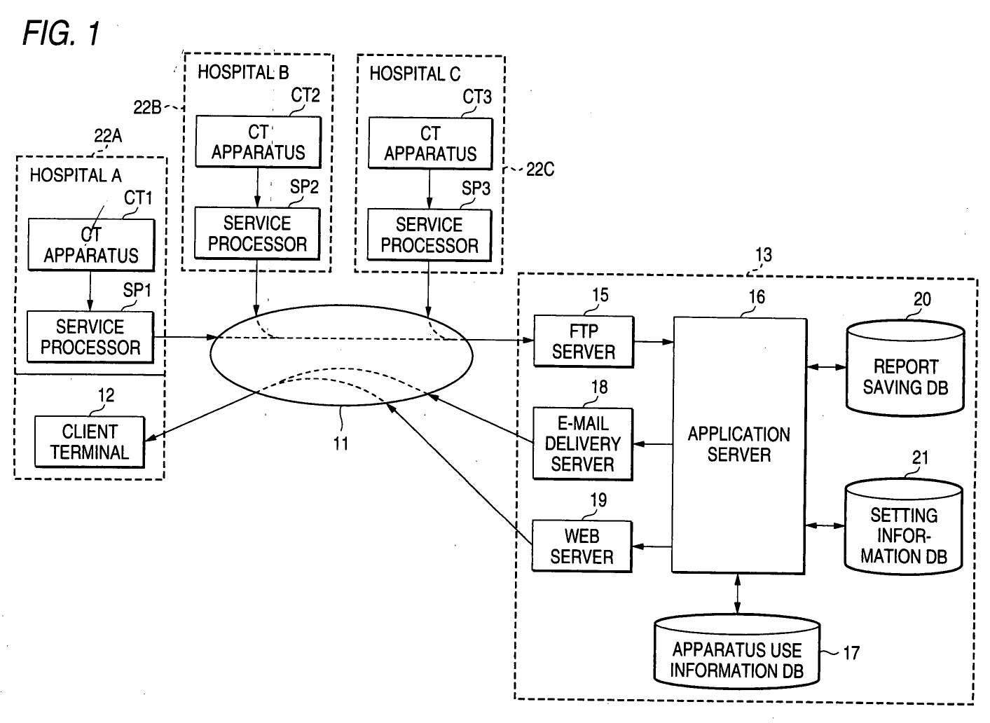

FIG. 1 shows an embodiment of an information provision system which collects information of a CT (Computed Tomography) apparatus as a medical apparatus in the present invention. This information provision system includes an information collection and provision system 13 in a service center and medical facility systems 22A, 22B and 22C, which are connected by a network 11 such as a private communication line or the Internet.

The medical facility system 22A includes a CT apparatus CT1 and a service processor SP1 which are set in a hospital A. The medical facility system 22B includes a CT apparatus CT2 and a service processor SP2 which are set in a hospital B. The medical facility system 22C includes a CT apparatus CT3 and a service processor SP3 which are set in a hospital C.

These service processors receive information from the corresponding CT apparatuses via local area networks in the medical facilities, store the information, and send the information to the information collection and provision system 13 in the service center. The information may be sent from the service processors to the information collection and provision system 13 periodically or may be sent in response to a request from the information collection and provision system 13.

In the medical facility system 22A, a client terminal 12 is also set. The client terminal 12 includes a mail program (not shown) for sending and receiving electronic mails and a web browser (not shown) for communicating with a web server 19 to display and input information.

The information collection and provision system 13 includes an FTP server 15 which receives information of the CT apparatuses CT1, CT2 and CT3 which is sent from the service processors of the respective hospitals, an application server 16 which analyzes the information of the CT apparatuses CT1, CT2 and CT3 and prepares a notice report, an apparatus use information database (DB) 17 which stores the information of the CT apparatuses CT1, CT2 and CT3 as databases, a mail delivery server 18 which sends necessary information to a predetermined registered electronic mail address as an electronic mail, a web server 19 which sends information in the HTML format in response to a request form the web browser of the client terminal 12, a report saving DB 20 which saves report information sent by an electronic mail, and a setting information DB 21 which stores setting conditions for each user related to report delivery.

The report saving DB 20 is a database in which dates on which reports are sent by electronic mails, information on notice destinations such as electronic mail addresses, and information on reports are associated with each other. The setting information DB 21 is a database in which identification information for specifying users (user IDs), delivery times of a periodical report, a format of the periodical report, notice destinations (electronic mail addresses, etc.) of the periodical report, judgment conditions for an emergency notice, a format of the emergency notice, information on notice destinations of the emergency report, a report format for inspection by the web browser, and the like are associated with each other.

The service processors SP1, SP2 and SP3 in the hospital A, the hospital B, and the hospital C send the information of the respective CT apparatuses CT1, CT2 and CT3 to the information collection and provision system 13 via a network 11 at a predetermined time interval such as once a week or once a month.

On the other hand, the information collection and provision system 13 analyzes the collected information of the CT apparatuses CT1, CT2 and CT3 to prepare a report and sends the report to doctors, engineers, administrators, and the like, who require the information, periodically or instantly if contact is required emergently.

First, information of the respective CT apparatuses CT1, CT2 and CT3, which are sent from the service processors SP1, SP2 and SP3 to the information collection and provision system 13, will be described.

Information which is generated in the CT apparatuses CT1, CT2 and CT3 includes information on an apparatus itself indicating an operation state of the apparatus (apparatus information) such as failure information and maintenance information on a repairing state or the like, and use information indicating who examined what kind of image of which portion of which patient with the apparatus. The former information and the latter information are collectively referred to as apparatus use information.

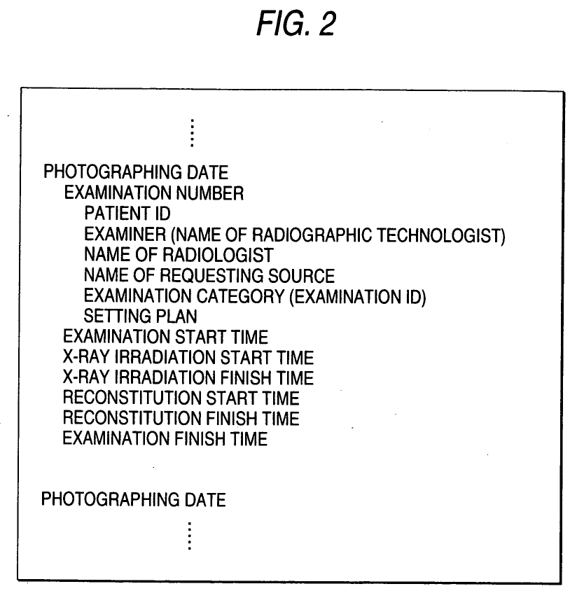

In the case of the CT apparatus, the use information is recorded and stored in the use information DB 17, for example, in a format as shown in FIG. 2. In other words, the use information consists of a patient ID specified by an examination number, an examiner (a name of a radiographic technologist), a name of a radiologist, a name of a requesting source, an examination category (an examination ID), a setting plan, an examination start time, X-ray irradiation start time, X-ray irradiation finish time, reconstitution start time, reconstitution finish time, and an examination finish time for each date of photographing.

Note that the application server 16 in this embodiment is implemented as application software constituting a software component which is executed by a computer mounted to the information collection and provision system 13, and carries out functions of the user identifying unit, the report delivery judging unit, and the report preparing unit in the present invention.

In addition, the apparatus use information database (DB) 17 in this embodiment constitutes the first data table of the present invention, and the setting information DB 21 constitutes the second data table. Moreover, the mail delivery server 18 and/or the web server 19 constitutes the output unit in the present invention.

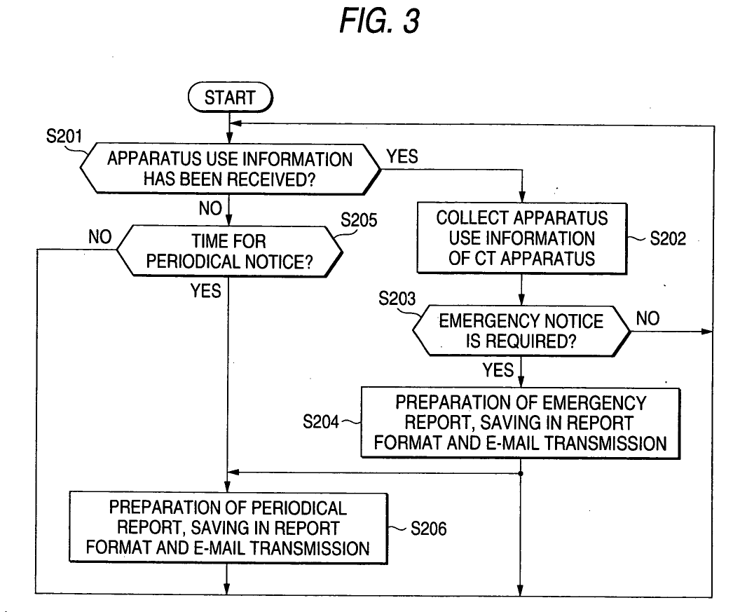

FIG. 3 is a flowchart of report notice processing with an electronic mail which is performed by the information collection and provision system 13.

In step S201, the information collection and provision system 13 judges whether or not apparatus use information has been received in the FTP server 15. If the apparatus use information has been received, the information collection and provision system 13 proceeds to step S202 and, if the apparatus use information has not been received, the information collection and provision system 13 proceeds to step S205.

In step S202, the information collection and provision apparatus 13 collects apparatus use information. The service processors SP1, SP2 and SP3 send the apparatus use information collected from the respective CT apparatuses CT1, CT2 and CT3 to the FTP server 15 as an encrypted file. The FTP server 15 receives the file of the apparatus use information, and the apparatus use information is saved in the apparatus use information DB 17 through the application server 16.

In step S203, the information collection and provision system 13 judges whether or not an emergency notice (alert) is necessary. The application server 16 reads out emergency notice judgment conditions for users corresponding to the collected apparatus use information from the setting information DB 21 and judges whether or not the apparatus use information complies with the judgment conditions. If the apparatus use information complies with the emergency notice judgment conditions, the information collection and provision system 13 proceeds to step S204 and, if the apparatus use information does not comply with the emergency notice judgment conditions, the information collection and provision system 13 returns to step S201.

In step S204, the information collection and provision system 13 emergently notifies the users of abnormality of the apparatuses. The application server 16 reads out a format of an emergency report corresponding to identification information of the users of the CT apparatuses CT1, CT2 and CT3 from the setting information DB21, and prepares a report including numerical values and graphs representing states of the apparatuses on the basis of the format of the emergency report and the result of analysis of the apparatus use information. The mail delivery server 18 sends the prepared report to emergency notice destinations registered in the setting information DB 21 and informs the users of the abnormality of the apparatuses. At the same time, the application server 16 saves the emergency report, a transmission date, identification information (ID) of relating medical apparatuses, and transmission destination of electronic mails in the report saving DB 20.

In step S205, the information collection and provision system 13 judges whether or not it is a time for delivering the periodical report. The application server 16 judges whether or not it is a time for delivering reports for the respective users using a timer or the like. This time for delivery can be set on the basis of setting for each user saved in the setting information DB 21 and can be set for each report type. In addition, as the time for delivery, a delivery month or the like may be calculated on the basis of a date of an agreement for the service. If it is the time for delivery for some report, the information collection and provision system 13 proceeds to step S206 and, if the time for delivery has not come for any report, the information collection and provision system 13 returns to step S201.

In step S206, the information collection and provision system 13 sends the periodical reports of the apparatuses to the users with electronic mails. The application server 16 reads out periodical report formats for the users to whom the periodical reports are delivered, from the setting information DB 21, and analyzes the apparatus use information of the apparatus use information DB 17 to prepare reports including numerical values and graphs representing states of the apparatuses in the format of the periodical reports. The mail delivery server 18 sends the prepared reports to periodical notice destinations registered in the setting information DB 21 with electronic mails and perform periodical reporting to the users. At the same time, the application server 16 saves the periodical reports, a date of transmission, and the transmission destinations of the electronic mails in the report saving DB 20.

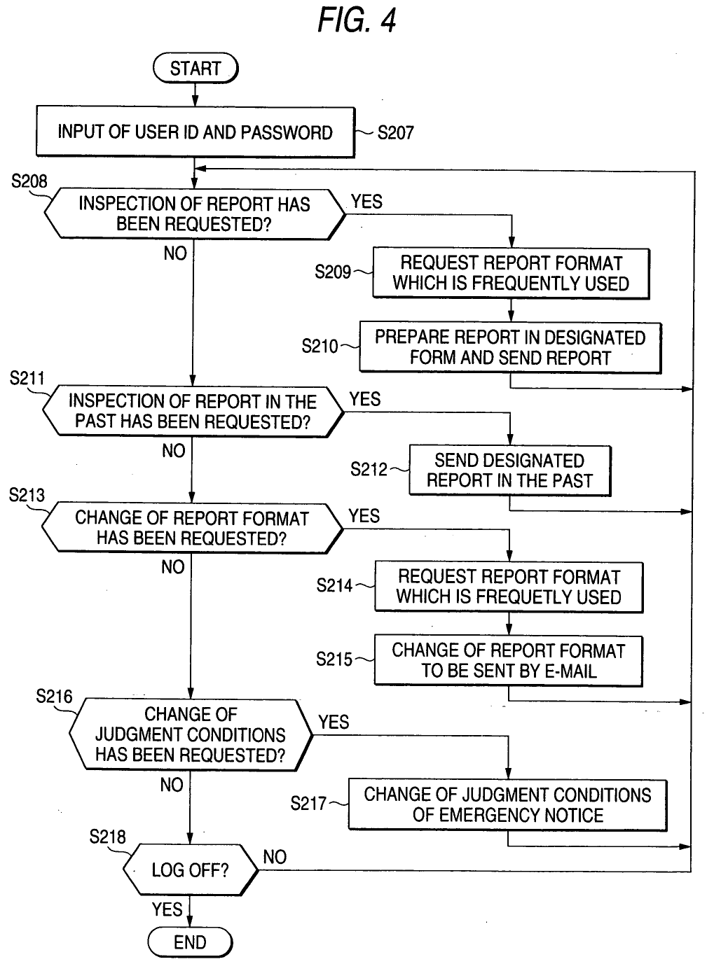

FIG. 4 is a flowchart of processing which is performed by the information collection and provision system 13 in response to a request from a web browser of a user.

When the user operates the web browser of the client terminal 12 to access a web page of the service center, in step S207, the information collection and provision system 13 confirms a user ID and a password. If the user ID and the password are correct, the information collection and provision system 13 proceeds to step S208. Note that, as this approval of access, a predetermined approval server may confirm whether or not the user is a proper user using an encryption communication technique such as SSL.

In step S208, the information collection and provision system 13 judges whether or not the user has instructed request for inspection of a report on the web browser of the client terminal 12. If the user has instructed request for inspection of the report, the information collection and provision system 13 proceeds to step S209 and, if the user has not instructed request for inspection of the report, the information collection and provision system 13 proceeds to step S210.

In step S209, the information collection and provision system 13 finds a report format which is frequently used. The application server 16 reads out formats of periodical reports and emergency reports registered by the respective users from the setting information DB 21 and analyzes the formats to find a frequently used report format among the registered report formats. For example, the information collection and provision system 13 adopts a set value, which is frequently used for at least one of the group consisting of a display form, a display period, an evaluation item, an evaluation viewpoint, and the like of a graph in the report, as a recommended value.

In step S210, the information collection and provision system 13 provides a report for a state of use of the apparatus on the basis of the format of the report designated on the web browser. The application server 16 reads out a report format for inspection by the web browser which is registered for the user, from the setting information DB 21, prepares a report representing a result of analysis of a state of the apparatus in accordance with the report format, and sends the report to the web browser through the web server 19. If the report format for the web browser is not registered, the information collection and provision system 13 prepares a report on the basis of the recommended value found in step S209. In addition, the user can confirm a state of the apparatus in various report formats as required by changing report formats on the web browser.

In step S211, the information collection and provision system 13 judges whether or not the user has instructed request for inspection of a report in the past on the web browser of the client terminal 12. If the user has instructed request for inspection of the report, the information collection and provision system 13 proceeds to step S213 and, if the user has not instructed request for inspection of the report, the information collection and provision system 13 proceeds to step S212.

In step S212, the information collection and provision system 13 provides periodical and emergency reports which were sent in the past by an electronic mail. The application server 16 searches through the report saving DB 20, retrieves reports sent by the present user in the past, and sends information on a list of the reports to the web browser through the web server 19. The list is displayed on the web browser and, when the user selects a necessary report out of the list, information on the selection is sent to the application server 16. The application server 16 reads out information on the selected report from the report saving DB 20 and sends the information to the web browser. The same contents as those of the report sent by the electronic mail in the past are displayed on the web browser.

In step S213, the information collection and provision system 13 judges whether or not the user has instructed change of formats of periodical and emergency reports, which are delivered by electronic mails, on the web browser of the client terminal 12. If the user has instructed change of the formats, the information collection and provision system 13 proceeds to step S214 and, if the user has not instructed change of the formats, the information collection and provision system 13 proceeds to step S216.

In step S214, the information collection and provision system 13 finds a frequently used report format. The application server 16 reads out formats of periodical and emergency reports, which are registered by the respective users, from the setting information DB 21 and analyzes the formats to find a frequently used report format among the registered report formats.

In step S215, the information collection and provision system 13 registers and changes a format of a periodical report and a format of an emergency report on the basis of the user's input to the web browser. The web server 19 sends a signal for displaying a screen for changing a report format to the web browser according to a request from the web browser of the client terminal 12. When the user designates a report format on the displayed screen, the report format is saved in the setting information DB 21 through the web server 19 and the application server 16. Consequently, the user himself/herself can set the formats of the periodical and emergency reports, which are sent to the user in steps S204 and S206, to arbitrary formats.

Note that, in designating a report format, if the user selects display in a recommended format, the information collection and provision system 13 displays the frequently used report format which was found in step S209, as a recommended format. When the user designates registration of this recommended format on the web browser, this recommended format is registered in the setting information DB 21, and the periodical and emergency reports will be delivered in this recommended format.

In step S216, the information collection and provision system 13 judges whether or not the user has instructed change of judgment conditions for an emergency notice on the web browser of the client terminal 12. If the user has instructed change of the judgment conditions, the information collection and provision system 13 proceeds to step S217 and, if the user has not instructed change of the judgment conditions, the collection and provision system 13 proceeds to step S218.

In step S217, the information collection and provision system 13 registers and changes judgment conditions for an emergency report on the basis of the user's input to the web browser. The web server 19 sends a signal for displaying a screen for changing the judgment conditions for an emergency notice to the web browser, in response to the request from the web browser of the client terminal 12.

When the user designates conditions for judging whether or not an emergency notice is sent such as temperature, humidity, and an input power level on the displayed screen, the conditions are sent to the setting information DB 21 through the web browser 19 and the application server 16 and saved as emergency notice conditions. Consequently, it becomes possible for the user to set conditions for judging whether or not an emergency notice is required in step S203 to arbitrary conditions in accordance with a state of use.

In step S218, the information collection and provision system 13 judges whether or not the user has instructed logoff on the web browser of the client terminal 12. If the user has instructed logoff, the information collection and provision system 13 performs end processing and, if the user has not instructed logoff, the information collection and provision system 13 returns to step S208.

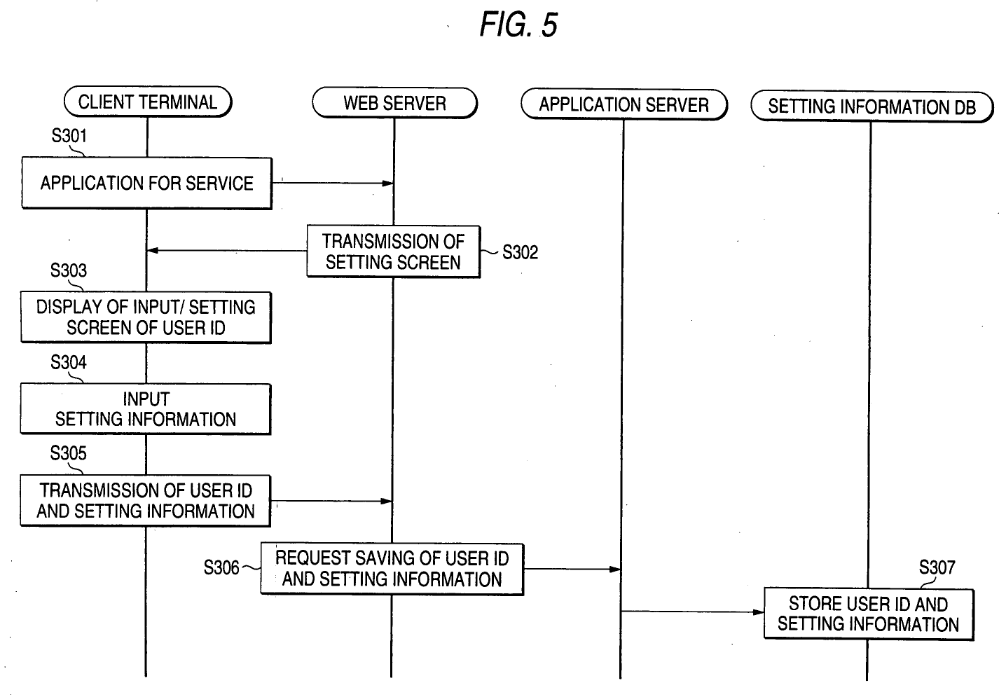

Next, a transmission setting mode for sending designation and display format setting for apparatus use information, which is sent from the information collection and provision system 13, from the web browser of the client terminal 12 to the information collection and provision system 13 will be described with reference to FIG. 5.

In FIG. 5, when an application for this service is sent from the client terminal 12 in step S301, the web server 19 in the information collection and provision system 13 receives the application and sends a setting screen for designating information which the user desires to receive, and a transmission format to the client terminal 12 (step S302).

In step S303, after the user inputs a user ID and a password and approval work is performed, the client terminal 12 displays the setting screen. In step S304, on the displayed setting screen, the user inputs information indicating the desired information and a format in which the information is displayed. Note that the setting screen on which the user inputs the information from the client terminal 12 at this point will be described later.

In the next step S305, the client terminal 12 sends the user ID and setting information inputted by the user to the web server 19. The Web server 19 requests the application server 18 to save this setting information (step S306). The application server 16 sends the setting information to the setting information DB 21 and stores the setting information in this database in association with the user ID.

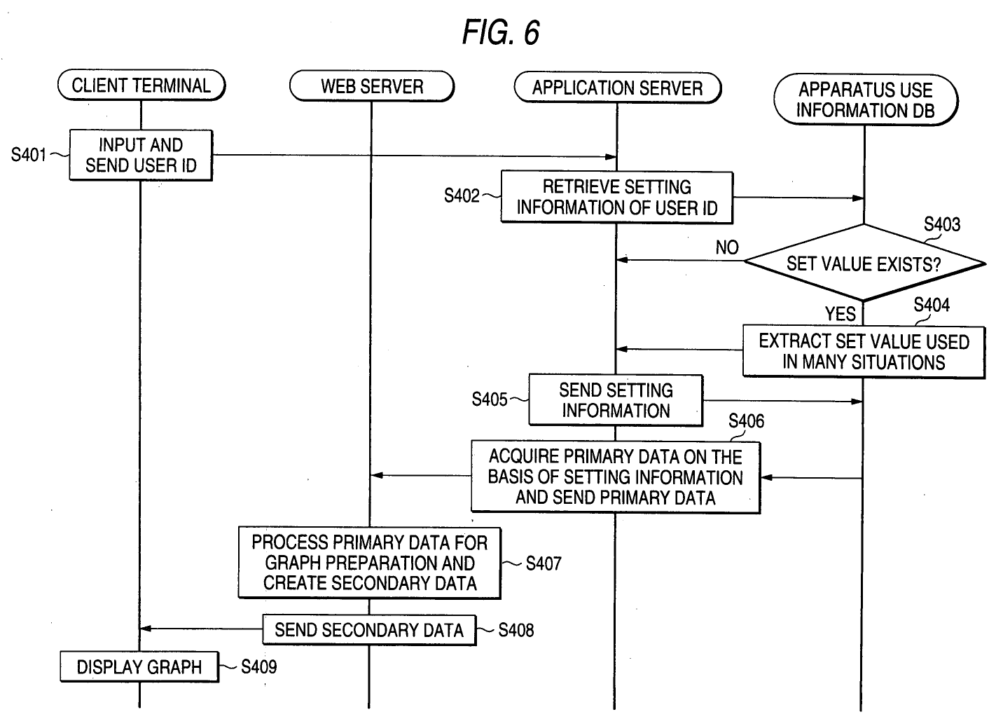

Next, a display mode for displaying apparatus use information in a predetermined display format will be described with reference to FIG. 6. In the case in which the user desires to display the apparatus use information of the respective CT apparatuses, which is stored in the apparatus use information DB 17 of the information collection and provision system 13, in a format set and inputted in advance by the user himself/herself, as shown in step S401 in FIG. 6, first, the user inputs a user ID to request a service, and data of the user ID and the request is sent to the application server 16 in the information collection and provision system 13 from the client terminal 12. The application server 16 retrieves setting information stored in the apparatus use information DB 17 on the basis of the user ID sent from the client terminal 12 (step S402).

In step S403, it is checked whether or not a set value exists in the retrieved setting information and, if the set value exists, the application server 16 is informed to that effect. On the other hand, if the set value does not exist in the retrieved setting information, in step S404, a value which is frequently used in general is extracted as a set value, and setting information for the set value is sent to the application server 16.

The application server 16 send the setting information to the apparatus use information DB17, in step S405, and acquires apparatus use information (primary data, e.g., the apparatus use information shown in FIG. 2) based on the setting information, in step 406, and sends the apparatus use information to the web server 19.

The web server 19 processes the received primary data to find secondary data (values of index items) for preparing a graph, a table, numerical values, and the like of the report set earlier (step s407), and prepares a report on the basis of the secondary data and sends the report to the client terminal 12 (step S408). The client terminal 12 displays the report sent from the web server 19.

Next, a case in which the user performs operation using the web browser of the client terminal 12 will be described.

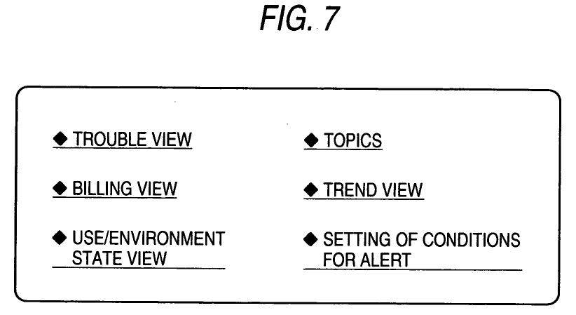

FIG. 7 is an example of an input screen which is displayed on the web browser of the client terminal 12 first after the user approval. In FIG. 7, “trouble view” is an item for viewing a history of each object apparatus to find if there was a trouble in the object apparatus, “topics” is an item for viewing recent topics, “billing view” is an item for viewing matters related to bills, “trend view” is an item for viewing recent trends, “states of use/environment view” is an item for viewing a state of use and an state of environment of an apparatus, and “setting of conditions for alert” is an item for changing setting of a periodical report and an emergency report.

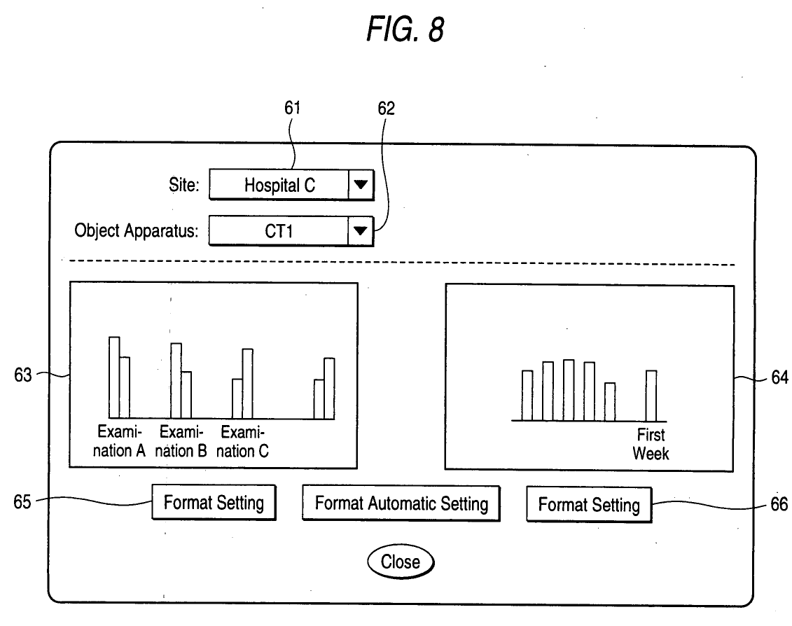

FIG. 8 is a screen for displaying the state of environment and is used in step S210. This screen can be displayed by clicking the item of “states of use/environment” on the screen of FIG. 7. The user selects a name of a site, that is, in this case, a hospital, for example, the hospital A and inputs the name in a site input section 61, and selects, for example, the CT apparatus CT1 as a diagnostic apparatus and inputs the CT apparatus CT1 in an object apparatus input column 62.

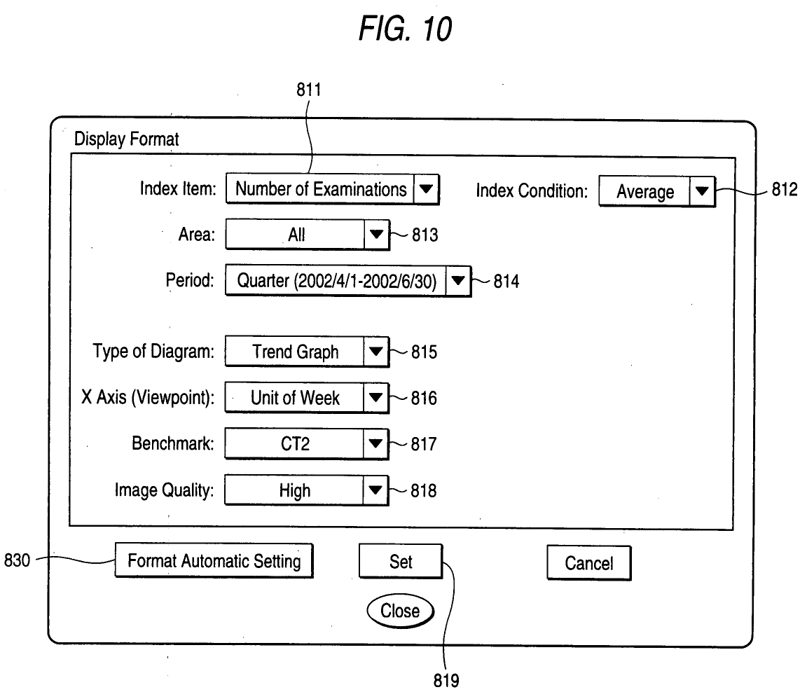

Consequently, a state of use, environmental information, and the like of the diagnostic apparatus are displayed in data display areas 63 and 64. When the user clicks format setting buttons 65 and 66 below the data display areas 63 and 64, a screen for setting a display format of the data display areas 63 and 64 appears, and a display format, a range of data, and the like can be changed. As the format setting buttons 65 and 66, the same format setting buttons as those shown in FIG. 10 described later can be used.

As these selectable set values, it is sufficient that, if a content which has often been selected to date is set as an initial value, for example, if a quarter has often been selected as a data period, the quarter is set as an initial value, and the initial set value is selected if the user does not change the setting specifically.

In this way, there is an advantage that, even if the user performs setting specifically, a set value which has been used most often can be selected, and setting can be performed very easily, for example, even in the case in which there are many set values. This is true for set values other than the data period.

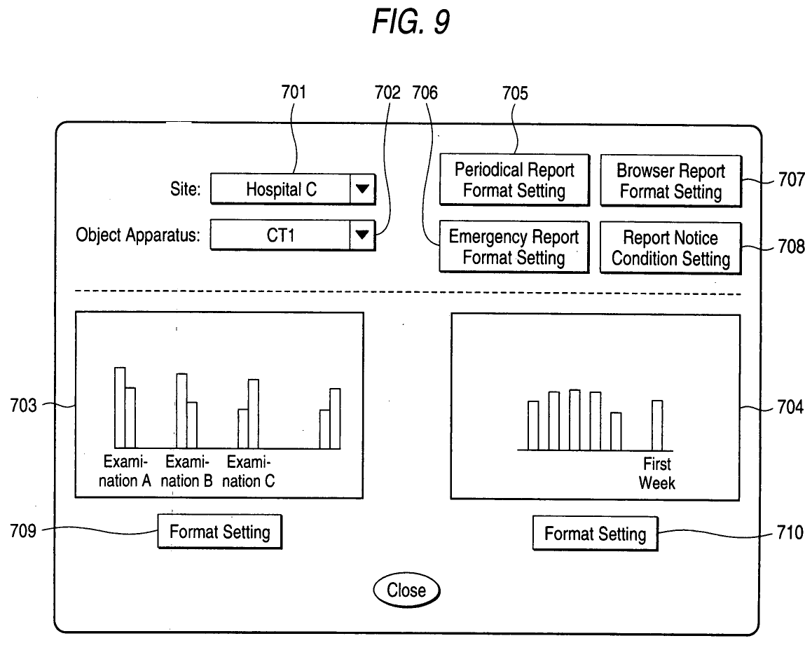

FIG. 9 is a screen for setting notice conditions for a report. The screen can be displayed by clicking the item of “setting of conditions for alert” on the screen of FIG. 7. The screen is used in step S215.

A site input section 701 is an input section for designating a medical facility such as a hospital to be an object of a report. An object apparatus input section 702 is an input section for designating a medical diagnostic apparatus to be an object of a report.

In data display areas 703 and 704, data of a result of analysis related to the designated medical facility and diagnostic apparatus is displayed as a diagram, a table, numerical values, or the like. In the case in which a display format of the data display areas 703 and 704 are changed, a screen for setting a display format can be displayed by pressing format setting buttons 709 and 710.

Note that input to the input sections may be performed by any one of a method of inputting an item or the like directly, a method of selecting an item out of presented selection items to input the selected item, and the like. When the user presses a report format setting button 705 periodically after setting a display format, the display format currently used for the display in the data display areas 703 and 704 is registered in the setting information DB 21 as a periodical report format.

Consequently, thereafter, the periodical report prepared in step S206 is sent in this format. In addition, the display format is stored in the setting information DB 21 in association with the user ID as an emergency report format in the case in which an emergency report format setting button 706 is pressed and as a report format for inspection in the web browser in the case in which a browser format setting button 707 is pressed, respectively.

FIG. 10 is a format setting screen which is displayed when the user presses format setting buttons 709 and 710. An index item input section 811 is an input section for setting index items (the number of examinations, an X-ray irradiation time, temperature, humidity, etc.) to be arranged as a diagram. An index condition input section 812 is an input section for setting a data extraction condition (total, maximum value, average value, minimum value, etc.) for each section of each viewpoint. An area input section 813 is an input section for setting a portion (all, head, chest, etc.) of a subject. A period input section 814 is an input section for setting a period of a date of occurrence of apparatus use information to be analyzed statistically in a diagram. A diagram type input section 815 is an input section for setting the type of a diagram. A viewpoint input section 816 is an input section for setting an item of a viewpoint such as time during which change in the diagram is observed, a person who observes the change in the diagram, an apparatus which observes the change in the diagram, the kind of an examination plan for observing the change in the diagram, and the like (an item corresponding to the X axis of the diagram and for each month, each week, each laboratory technician, each apparatus, each examination plan, etc.). A benchmark input section 817 is an input section for setting a medical diagnostic apparatus to be an object of comparison. An image quality input section 818 is an input section for setting a level (high, medium, low) of an image quality of a diagram to be displayed.

A setting button 819 is an input button for setting a display format which is inputted in the screen, as a setting condition for the corresponding data display areas 703 and 704. A format automatic setting button 830 is an input button for automatically setting a candidate of a display format on the basis of the recommended format found in steps S210 and S214. By pressing this button, at least one of the group consisting of an index item, an index condition, a type of a diagram, a viewpoint, and a period is automatically set to one which is frequently used. A benchmark is adapted such that same kinds of apparatuses in the same hospital or same kinds of apparatuses in different hospitals can be compared.

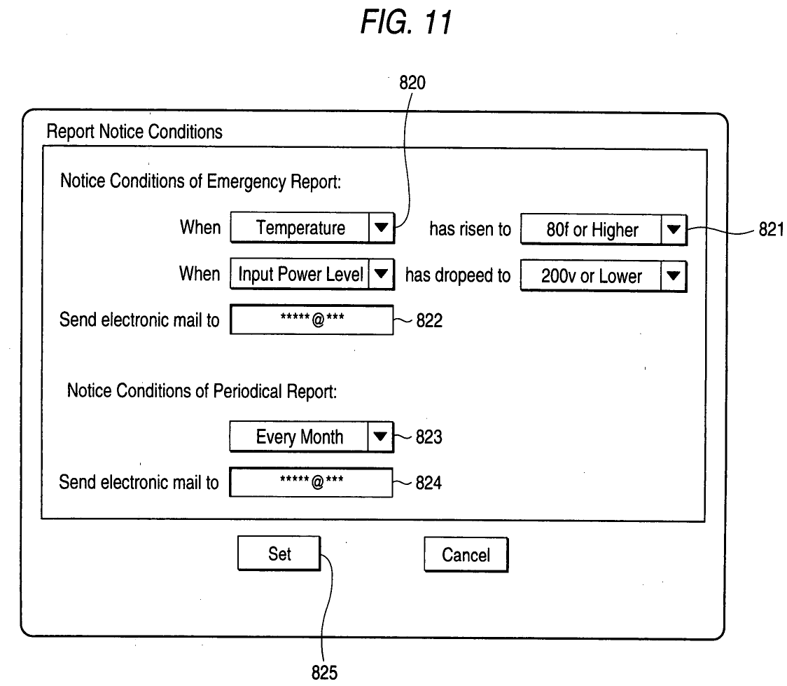

FIG. 11 is a screen for setting notice conditions for a report with an electronic mail which is displayed at the time when a report notice condition setting button 708 is pressed. This screen is used in step S217, and notice judgment conditions set here are used in steps S203 and S205.

A detection item input section 820 is an input section for setting detection items (temperature, humidity, an input power level, etc.) of notice judgment conditions for an emergency report. A detection condition input section 821 is an input section for setting values of detection conditions. An address input section 822 is an input section for setting a notice destination of an emergency report. A periodical notice condition input section 823 is an input section for setting conditions for a periodical notice time (each week, each month, each quarter, etc.). An address input section 823 is an input section for setting a notice destination of a periodical report. After input to the respective input sections is completed, by pressing a setting button 825, notice conditions set on this screen a restored in the setting information DB 21 in association with a user ID.

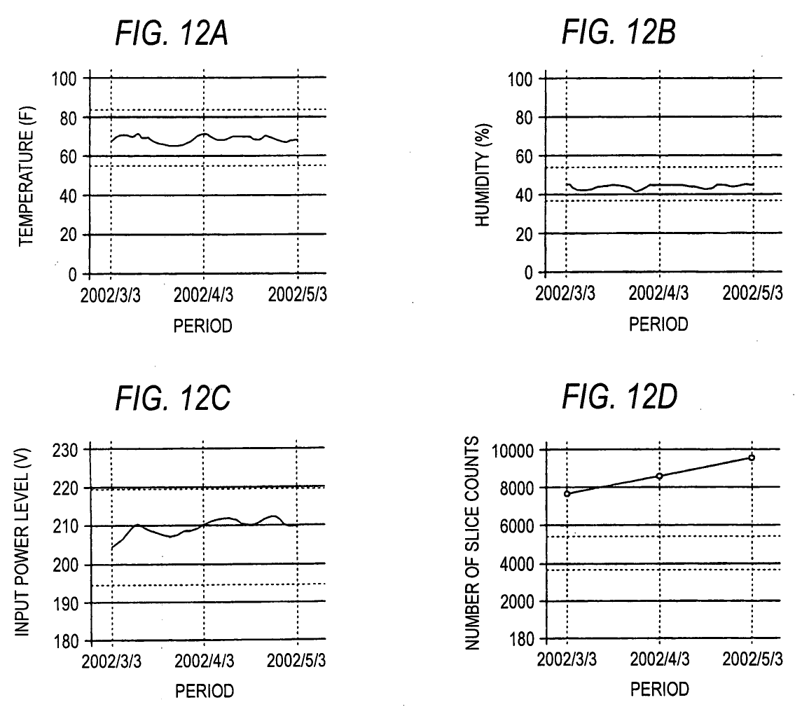

FIG. 12A is an example of displaying a graph of temperature change in a predetermined period on the screen of the client terminal 12. This graph shows a display example in the case in which “temperature” is designated in the index item input section 811, “average in one day” is designated in the index condition input section 812, and “from Mar. 3, 2002 to May 3, 2002” is designated in the period input section 814.

In this figure, the horizontal axis indicates a date and the vertical axis indicates a temperature in Fahrenheit (F) In this graph, dotted lines near 55 degrees and 85 degrees are straight lines which indicate that an apparatus will be in danger if a temperature rises or falls exceeding the lines (danger lines). For example, when a temperature of the apparatus approaches such temperatures, it is possible to inform the user that the temperature of the apparatus is close to the danger lines by sending the information to the client terminal 12 through the mail server 18.

Note that, in the input screen shown in FIG. 10, if “temperature” is inputted in the index item input section 811 and “a highest value and a lowest value in one day” is selected and inputted in the index condition input section 812, a highest temperature and a lowest temperature in each day of the apparatus can be displayed.

FIG. 12B is a display example in the case in which “humidity” is designated in the index item input section 811. Consequently, a change with time of humidity in a predetermined period of the CT apparatus CT1 can be learned on the screen of the client terminal 12. Dotted lines located at 35% and 55% in this figure also indicate danger lines for humidity.

FIG. 12C is a display example in the case in which “input power level” is designated in the index item input section 811. Consequently, an input power level (V) for two months from Mar. 3, 2002 can be displayed as a graph with time. Dotted lines near 195 V and 220 V in this case also indicate danger lines for an input power level.

FIG. 12D is a display example in the case in which “the number of slices” is designated in the index item input section 811. In this graph, the total number of slices for each month of tomographic images collected by the CT apparatus is displayed. In addition, when “head” is designated in the area input column 813, the total number of slices of tomographic images of heads can be displayed as a graph.

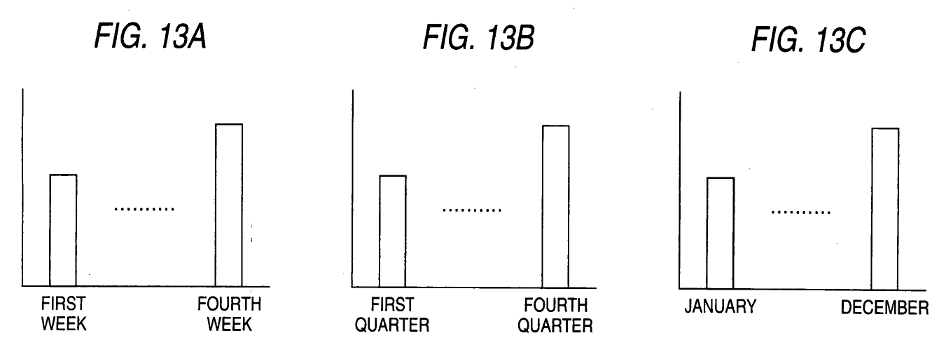

FIGS. 13A to 13C are display examples in the case in which a value in the period input section 814 is changed on the input screen shown in FIG. 10. FIGS. 13A to 13C indicate display examples in the case in which latest four weeks, four quarters, and twelve months are selected, respectively.

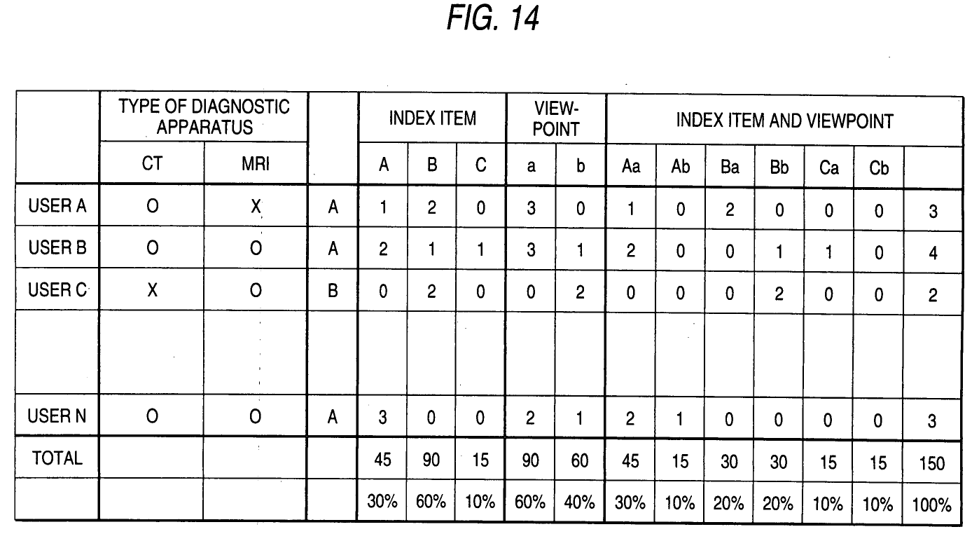

FIG. 14 is a diagram showing a state of setting for a report for each user stored in the setting information DB 21. This figure includes a type of a diagnostic apparatus which a user set for a report, the number of times of use for each index item, the number of times of use for each viewpoint, and the number of times of use for each combination of an index item and a viewpoint. A total for each number of times of use is found, and a rate of use for each index item, a rate of use for each viewpoint, and a rate of use for each combination of an index item and a viewpoint are found from the total. A set value with the highest rate of use is a set value which is used most frequently. In steps S209 and S214, this value is found as a recommended value.

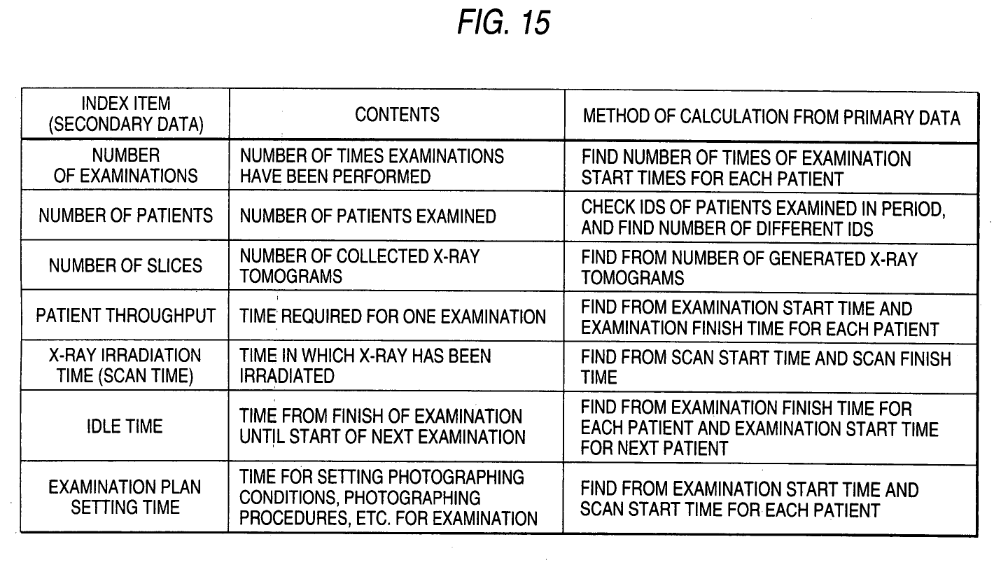

FIG. 15 shows an example of converting primary data collected from a diagnostic apparatus into values (secondary data) of index items for generating a graph, a table, and the like. The application server 16 converts primary data collected from a diagnostic apparatus into secondary data according to a calculation method as indicated in this table.

According to the above-mentioned embodiment, although, only with a system in which a user looks at a report of an apparatus from a web browser, it is likely that the user overlooks the report, since the report is delivered to the user by an electronic mail, the overlooking can be prevented compared with the inspection by the web browser.

In addition, since a report format is saved for each user in the information collection and provision system 13 of the service center, in inspecting a report from the web browser, the user can refer to a report corresponding to the format simply by inputting a user ID. Since formats of periodical and emergency reports, which are delivered by electronic mails, are saved for each user, the user himself/herself can arbitrarily change a format of a report to be delivered.

Further, when abnormality has occurred in performance of an apparatus, since a notice is sent automatically by an electronic mail, a facsimile, or the like, a user can be informed of the abnormality promptly. Since a user himself/herself can change judgment conditions for sending an emergency notice, an emergency notice suitable for a state of the user can be sent.

Moreover, since reports sent by electronic mails are saved as a database, when a report in the past is necessary, the report can be inspected easily.

Note that, although only a kind and a display format of apparatus information or use information are sent from a client terminal in the above-mentioned embodiment, transmission time information which indicates when and at how long time interval a report is sent, can also be sent as setting information. In addition, although a report is delivered by an electronic mail in the above-mentioned embodiment, a report may be delivered by a facsimile or the like.

Second Embodiment

Next, a second embodiment of the present invention will be described with reference to the accompanying drawings. This embodiment relates, in particular, to setting for contents, an arrangement, and a format of a report which the information collection and provision system in accordance with the present invention sends to a user. Therefore, an overall constitution related to this embodiment is basically the same as that related to the first embodiment, reference to the respective components are denoted by the same reference numerals and signs, and figures and descriptions for the overall constitution will be omitted.

Items required by a user may vary depending upon modality to be used. In addition, even if reports include the same contents, a user usually wishes to look at the contents from one to which the user attaches importance. For example, a user attaches importance to how fast an examination is finished, and places patient throughput at the top of a report. On the other hand, there may be a user who attaches importance to the number of times of examination which is directly connected to an income.

Examples of such items include (1) the number of examinations, (2) examination time, (3) patient throughput, (4) operation time, (5) the number of image per examinations, (6) patient throughput—# of days, (7) examination plan time by examination plan, and (8) idle time by examination plan.

Moreover, even if an item is identical, which of numerical values for one day, one week, and one month is necessary varies depending upon a user. In addition, a display format for the numerical value, that is, a table or a graph, may also vary depending upon preference of a user.

Thus, an information collection and provision system 13A in accordance with this embodiment stores plural templates which correspond to general needs among such various needs, in the setting information DB 21.

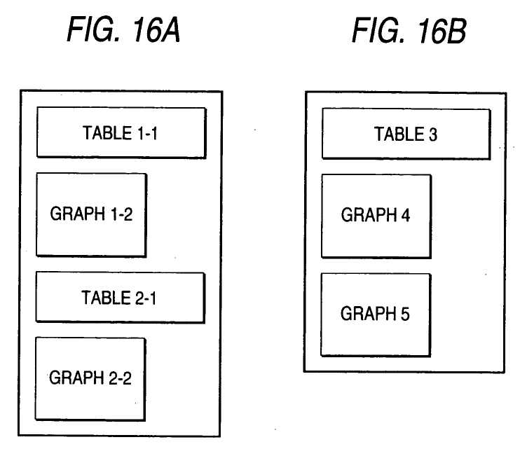

For example, a template shown in FIG. 16A displays an item 1 in a table format 1-1 and a graph format 1-2 and, then, arranges and displays another item 2 in a table format 2-1 and a graph format 2-2 in the same manner.

On the other hand, a template shown in FIG. 16B arranges and displays a first item 3 only in a table format, displays a second item 4 in a graph format, and displays a third item 5 in a graph format. In addition, as a graph format, a bar graph, a pie graph, or the like is designated according to a purpose. Moreover, as a font, a font size, a font color, a background color, a graph color, and the like, which are used in the respective tables and graphs, standard ones are designated.

However, even if such plural templates are stored, needs of all users are not necessarily satisfied. Thus, the information collection and provision system 13A in accordance with this embodiment includes report setting unit (report configuration tool) which changes these templates or prepares new templates.

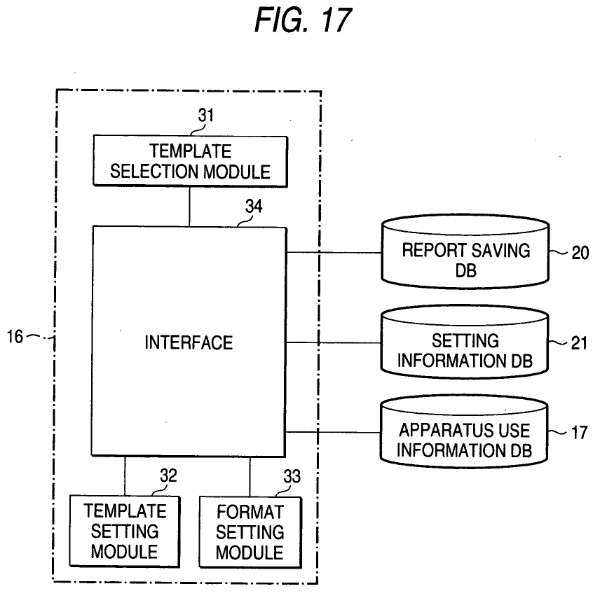

More specifically, as shown in FIG. 17, this report setting unit includes, in the application server 16, functional units, namely, a template selection module 31 which selects a desired template from plural templates stored in the setting information DB 21, a template setting module 32 which changes the selected template to a desired one or prepares a new template, and a format setting module 33 which changes a font size, a font color, a graph color, and a background color of this template to desired ones. Further, these modules, the setting information DB 21, the apparatus use information DB 17, and the like are connected via an interface 34.

These modules 31 to 34 are implemented as application software which constitutes a software component executed by a computer.

Processing by this report setting unit will be hereinafter described with reference to an input screen on the web browser which is provided in the client terminal 12 set in the medical facility system 22.

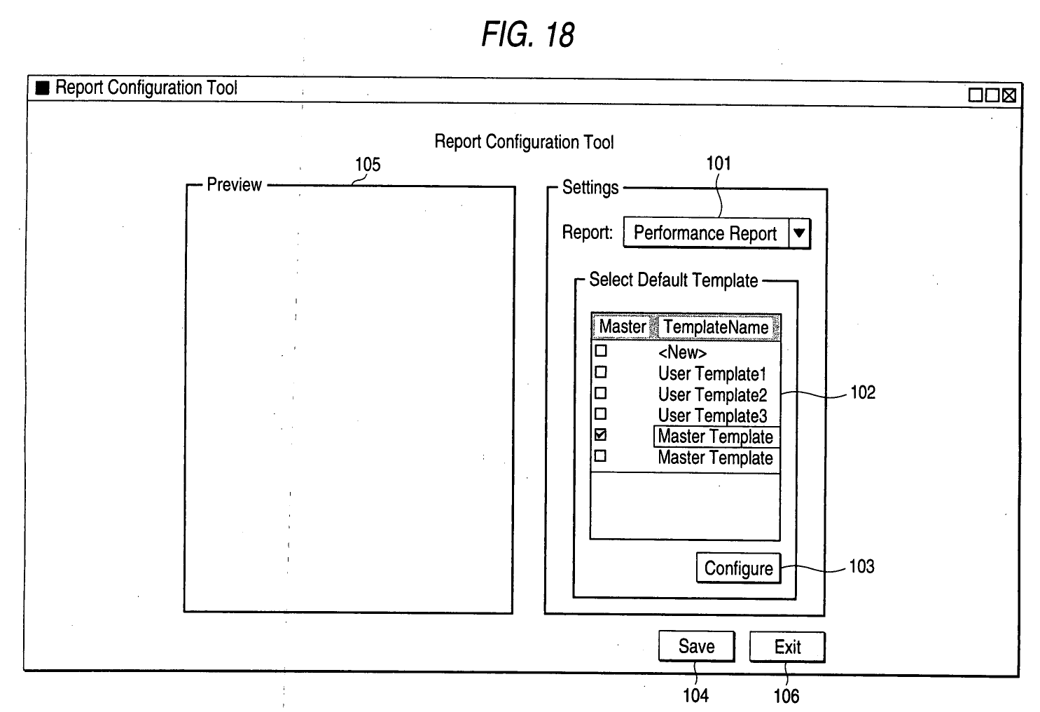

FIG. 18 is a main screen of the report setting unit which is displayed when a user or an administrator logs in a network. The template selection module 31 lists usable templates in a template list 102 from the plural templates stored in the setting information DB 21 via the interface 34 on the basis of user identification information.

In the case in which a user of the report setting unit is judged as an administrator according to the user identification information, only a master template is displayed. In the case in which a user of the report setting unit is judged as a general user according to the user identification information, the master template and a user template are displayed. A check box is checked for the master template, and both the users are distinguished. In addition, different kinds of templates are listed according to a type of modality provided in a hospital.

A currently selected template is displayed in a selection setting box 101, and a layout of this template can be viewed generally in a preview pane 105. In the case in which a user desires to change this selection, the user clicks and selects a desired template from a template list 102.

In the case in which the user selects a template in the template list 102 and changes a current setting, when the user clicks a saving button 104, information on the template is sent to the setting information DB 21 from the template selection module 31 via the interface 34. The selected template is saved as a current template and is displayed in the selection setting box 101 at the time of the next and subsequent startup of the apparatus.

On the other hand, when the user desires to correct a template listed in the template list 102, the user selects the template which the user desires to correct. In addition, when the user desires to prepare a template anew, the user selects <New> from the template list 102 and clicks the setting button 103. Consequently, the processing shifts to a template edition screen to be described later.

Then, when the user clicks an Exit button, the processing can exit this main screen and start preparation of a report.

The template setting module 32 executes edition processing on the template edition screen by collecting information from the template selection module 31 via the interface 34.

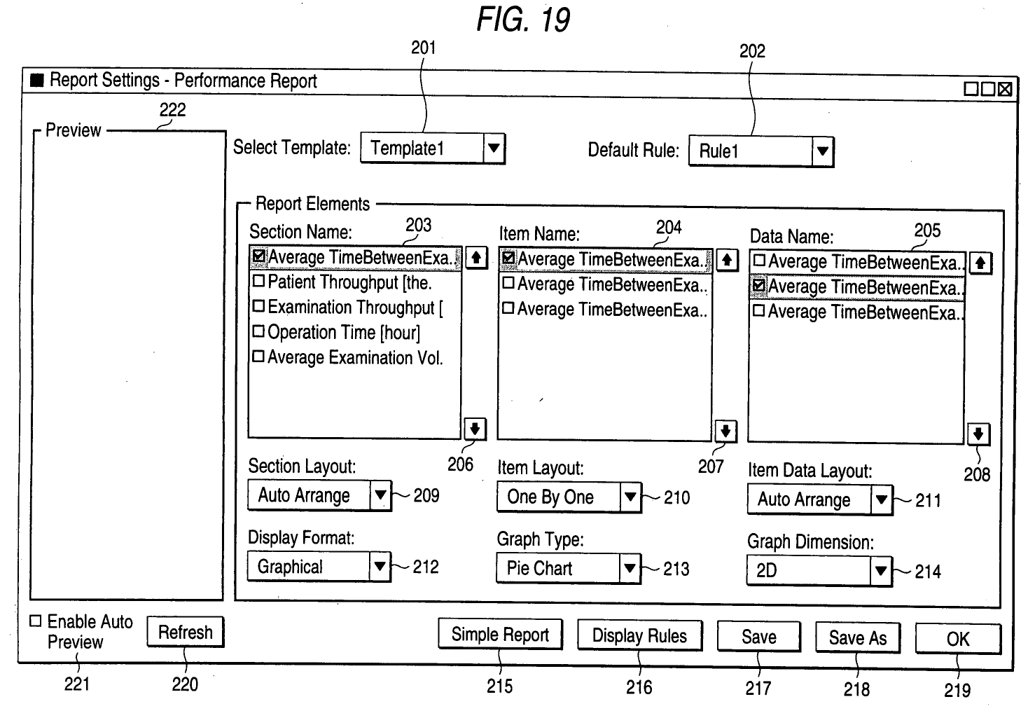

On the template edition screen, as shown in FIG. 19, a name of a template which is currently being edited, that is, the template which was selected in the template list 102 of the main screen of the report setting unit is displayed in a select template box 201. In addition, an initial value of a format of the template is displayed in a format box 202.

Then, on the template edition screen, candidates of contents which the user desires to incorporate in the report are listed in hierarchy in a section box 203, an item box 204, and an item data box 205. In other words, when the user selects one section from the section box 203, an item corresponding to the section is displayed in the item box 204. Similarly, when the user selects one item from the item box 204, item data corresponding to the item is displayed in the item data box 205.

The user can select a content which the user desires to incorporate in the report by checking listed check boxes of section, item, and item data, respectively. In addition, it is possible to move a selected item to an item immediately above or below the selected item to change an order of descriptions in the report by clicking up/down buttons 206 to 208 of each of the section box 203, the item box 204, and the item data box 205.

Concerning an arrangement of the section, the item, and the item data which have been selected so as to be described in the report, it can be chosen in respective layout boxes 209 to 211 whether the arrangement is automatically set or set one by one.

Then, it can be chosen in a display item box 212 whether the item is displayed in a table format or a graph format. In addition, when the item is displayed in the graph format, it can be chosen in a graph type box 213 whether the graph format is a bar graph or a pie graph. Moreover, it can be chosen in a graph dimension box 214 whether the graph is displayed two-dimensionally or three-dimensionally.

The layout and the like of the section, the item, and the item data selected in this way can be viewed generally and confirmed in a preview pane 222. A display of the preview pane 222 is updated every time an update button 220 is clicked or, if an automatic update button 221 is checked, this update is performed automatically. In addition, in the case in which a sample report button 215 is clicked, a sample of the report, which is edited as described above, is displayed.

If the user clicks a save button 217, such a result of edition is overwritten and saved. If the user clicks a save as button 218, a saving name input screen appears and the result is saved with a new name inputted on the saving name input screen. This instruction for saving is sent to the setting information DB 21 from the template setting module 32 via the interface 34.

Then, when an OK button is clicked, the processing exits this template edition screen and returns to the main screen of the report setting unit. If a format setting button 216 is clicked before that, the processing shifts to a format setting screen for changing a font and a color.

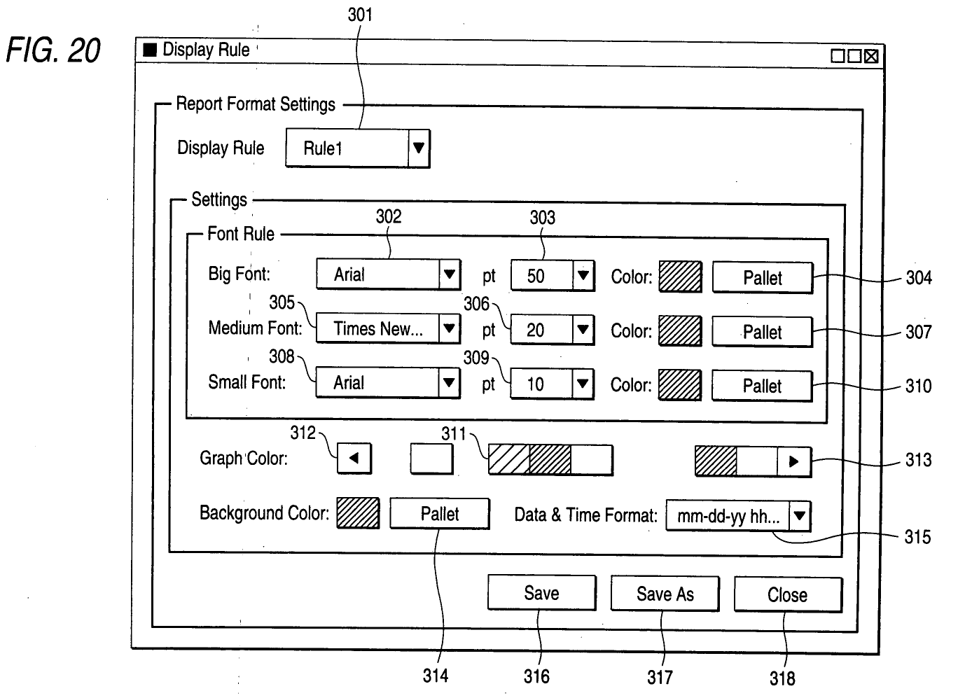

FIG. 20 shows the format setting screen. The format setting module 33 executes edition processing on the format setting screen by collecting information from the template selection module 31 via the interface 34.

The format selected in the format box 202 of the template edition screen is displayed in a format box 301. In the case in which <New> is selected in the format box 202, a completely new format is set in this format setting screen.

For large characters among characters used in the report, a font for the characters can be selected from a font box 302, and a size of the characters can be selected from a character size box 303. In addition, a character color can be selected from a character color pallet 304, and the selected color is displayed in a label on the left of the character color pallet 304. Medium sized characters and small characters can be selected by boxes or pallets 305 to 310 in the same manner.

Colors to be used in a graph are displayed in a graph color panel 311 in accordance with an order. In the case in which there are many colors to be used, the user can display the colors in the graph color panel 311 by clicking left and right scroll bars 312 and 313.

In addition, by right-clicking a mouse on the graph color panel 311, a popup menu is displayed, and the user can perform edition of addition (lastly), correction and insertion (in the middle), and deletion of colors.

The user can also select a background color from a background color pallet 314 in the same manner as selecting the character color. The selected color is displayed in a label on the left of the background color pallet 314. In addition, it is possible to select a format of date and time in a date and time box 315.

If the user clicks a save button 316, the above-mentioned result of edition is overwritten and saved and, if the user clicks a save as button 317, a saving name input screen appears, and the result is saved with a new name inputted on the saving name input screen. This instruction for saving is sent to the setting information DB 21 from the format setting module 33 via the interface 34.

Then, if a close button 318 is clicked, the processing exits this format setting screen and returns to the template edition screen.

Since the report setting unit is constituted and functions as described above, the user becomes capable of preparing a report with arbitrary contents, arrangement, and format.

The above-mentioned change of a template is reflected on the next and subsequent periodical reports. In addition, it is also possible to re-prepare a report which was prepared in the past, using a new template. Consequently, comparison of a report before the change of a template and a report after the change is facilitated.

What is claimed is:

1. An information collection and provision system, comprising:
a first data table which stores medical apparatus information which indicates an operation state of a medical apparatus, acquired via a network;
user identifying unit which authenticates user identification information (ID) acquired from a remote terminal apparatus;
a second data table which stores report delivery condition information which is acquired from the terminal apparatus, in association with the user identification information (ID);
a report delivery judging unit which judges whether or not it is a time for delivering a report on the basis of the first data table and the report delivery condition information;
a report preparing unit which prepares a report on the basis of a result of judgment by the report delivery judging unit; and
an output unit which outputs a result of preparation of a report by the report preparing unit via a network.

2. An information collection and provision system according to claim 1,
wherein the report shows information on at least one of the group comprising of an operation time of the medical apparatus, the number of patients examined by the medical apparatus, the number of examinations, an irradiation time of X-ray, a plan setting time for patients, an idle time of the medical apparatus, an examination time for patients, and the number of slices at which tomograms have been obtained.

3. An information collection and provision system according to claim 1,
wherein the report preparing unit includes at least one of an emergency report delivery judging unit and a periodical report delivery judging unit:
said emergency report delivery judging unit which determines delivery of a report when abnormality of performance is detected on the basis of parameters representing an examination state or information on the apparatus; and
said periodical report delivery judging unit which decides to distribute a report in every predetermined period.

4. An information collection and provision system according to claim 1,
wherein the report preparing unit includes:
a template selection module which selects a desired template out of plural templates defining contents, an arrangement, and a format of a report stored in the second data table;
a template setting module which changes the selected template to a template for desired contents, arrangement, and format and prepares a new template; and
a format setting module which changes a font size, a font color, a graph color, and a background color of the template to desired ones.

5. An information collection and provision system, comprising:
a first data table which stores medical apparatus information which indicates an operation state of a medical apparatus, acquired via a network;
a user identifying unit which authenticates user identification information (ID) acquired from a remote terminal apparatus;
a second data table which stores report output format information which is acquired from the terminal apparatus, in association with the user identification information (ID);
a report preparing unit which prepares a report for users using the medical apparatus information on the basis of the report output format information; and
an output unit which outputs a result of preparation of a report by the report preparing unit via a network.

6. An information collection and provision system, comprising:
a first data table which stores medical apparatus information which indicates an operation state of a medical apparatus, acquired via a network;
a user identifying unit which authenticates user identification information (ID) acquired from a remote terminal apparatus;
a second data table which stores report delivery time information which is acquired from the terminal apparatus, in association with the user identification information (ID);
a report delivery judging unit which judges whether or not it is a time for delivering a report on the basis of the first data table and the medical apparatus information;
a report preparing unit which prepares a report on the basis of the result of judgment by the report delivery judging unit; and
an output unit which outputs a result of preparation of a report by the report preparing unit via a network.

7. An information collection and provision method, comprising:
a first storage step of storing medical apparatus information which indicates an operation state of a medical apparatus, acquired via a network in a data table;
a user identification step of authenticating user identification information (ID) acquired from a remote terminal apparatus;
a second storage step of storing report delivery condition information acquired from the terminal apparatus in association with the user identification information (ID) in a data table;
a report delivery judgment step of judging whether or not it is a time for delivering a report on the basis of the data table in which the medical apparatus information is stored in the first storage step, and the report delivery condition information;
a report preparation step of preparing a report on the basis of the result of judgment by the report delivery judgment step; and
an output step of outputting a result of preparation of a report by the report preparation step via a network.

8. An information collection and provision method, comprising:
a first storage step of storing medical apparatus information which indicates an operation state of a medical apparatus, acquired via a network in a data table;
a user identification step of authenticating user identification information (ID) acquired from a remote terminal apparatus;
a second storage step of storing report output format information which is acquired from the terminal apparatus, in association with the user identification information (ID) in a data table;
a report preparation step of preparing a report for users using the medical apparatus information on the basis of the report output format information; and
an output step of outputting a result of preparation of a report by the report preparation step via a network.

9. An information collection and provision method, comprising:
a first storage step of storing medical apparatus information which indicates an operation state of a medical apparatus, acquired via a network in a data table;
a user identification step of authenticating user identification information (ID) acquired from a remote terminal apparatus;
a second storage step of storing report delivery time information which is acquired from the terminal apparatus, in association with the user identification information (ID) in a data table;
a report delivery judgment step of judging whether or not it is a time for delivering a report on the basis of the data table in which the medical apparatus information is stored in the first storage step, and the medical apparatus information;
a report preparation step of preparing a report on the basis of the result of judgment by the report delivery judgment step; and
an output step of outputting the result of preparation of a report by the report preparation step via a network.
